(19) United States
(12) Patent Application Publication
(10) Pub. No.: US 2007/0033132 A1
(43) Pub. Date: Feb. 8, 2007

(54) INTERNET ACCESS TRADING AND DISTRIBUTED SHARED FUNCTIONALITY

(76) Inventor: Anthony Defries, Los Angeles, CA (US)

Correspondence Address: MAINMAN LTD., 1922 BEL AIR RD., LOS ANGELES, CA, 90077, US

(21) Appl. No.: 11/458,849

(22) Filed: Jul. 20, 2006

Related U.S. Application Data
(60) Provisional application No. 60/701,085, filed on Jul. 21, 2005.
(60) Provisional application No. 60/701,498, filed on Jul. 22, 2005.

(51) Int. Cl. G06Q 40/00

(52) U.S. Cl. 705/37

(57) ABSTRACT

The present disclosure concerns a commercial method and trading model for acquisition, redistribution, enhancement, combination and sale of Internet access and media content. In some implementations the trading model may include a means to develop a business to embody the invention described herein. The method of such business could include trading Internet access and media content for online advertising, marketing or other revenue. The method could include trading, using, operating or otherwise dealing in Internet broadcasting, media content distribution and network communications. The disclosure further concerns a method to provide distributed shared functionality as a data processing or networking platform. The method could include a means to share or distribute tasks and functions and to distribute shared tasks or functions across a platform consisting of or on a data processing or information processing device or contained in a computer device or a network of such devices as a function of distributing shared files or sharing files for data processing tasks.

### RELATED APPLICATIONS

This application claims benefit of and priority to U.S. Provisional Patent Applications No. 60/701,085 filed Jul. 21, 2005 entitled “Commercial method and trading model for acquisition, redistribution, enhancement, combination and sale of Internet access and media content,” herein incorporated by reference in its entirety and U.S. Provisional Patent Application No. 60/701,498 filed Jul. 22, 2005 entitled “Method to provide distributed shared functionality as a data processing and computer networking platform,” herein incorporated by reference in its entirety.

### BACKGROUND

1. Field

The present disclosure concerns a commercial method and trading model for acquisition, redistribution, enhancement, combination and sale of Internet access and media content. In some implementations the trading model may include a means to develop a business to embody the invention described herein. The method of such business could include trading Internet access and media content for online advertising, marketing or other revenue. The method could include trading, using, operating or otherwise dealing in Internet broadcasting, media content distribution and network communications. The disclosure further concerns a method to provide distributed shared functionality as a data processing or networking platform. The method could include a means to share or distribute tasks and functions and to distribute shared tasks or functions across a platform consisting of or on a data processing or information processing device or contained in a computer device or a network of such devices as a function of distributing shared files or sharing files for data processing tasks.

2. Related Art

The development of global communications has had a profound effect on all public, private and commercial activities and given rise to the Information Industry and the Information Age. The Internet plays a central role in this activity and impacts diverse industries and services in the field of electronics, semiconductors, science and technology, communications, marketing, media, commerce, culture, entertainment, education and many others. There are a significant number of business organizations involved in the delivery and support of Internet infrastructure and services.

Development of network capabilities for computers and computing devices has led to increasing sophistication in the capacity and capability of computer networks. The Internet infrastructure, which permits those networks to be connected, is the subject of constant development and change. Recent innovations have led to the creation of a robust online model for all forms of commercial Internet access and transactions including business-to-business, business to consumer, government-to-business, government-to-consumer, consumer-to-consumer and marketing. Online advertising has become the highest growth sector of the marketing and advertising industry. The Internet serves as the major means of delivery for all forms of online marketing, promotion, branding and advertising traffic. Information technologies are fuelling explosive growth in Internet communications and software enterprises.

In the last decade there has been a dramatic increase in Internet use for online marketing, social networking and content distribution. Consumer special interest, dedicated, personal or focus groups of end users have contributed to this growth. There are significant obstacles to acquisition and distribution or redistribution of Internet access and content. These obstacles include technical, technological, financial, social, legal, consensual, privacy, moral, ethical, conceptual and commercial considerations. New models of online marketing and social networking have emerged through the development of hardware and software applications that support information and content distribution. These models have not yet been extended to the area of Internet access provisioning. The invention described herein would provide a means to improve and extend Internet access in the areas described. Substantial benefit would accrue to consumers, content owners, Internet access providers, Internet service providers, commerce, education, health and many other sectors of society by the invention described herein.

Computers and computing devices have been used for the simultaneous processing of many different tasks or functions. Such devices were connected in parallel or series and programmed to separate those tasks or functions into separate or discrete files. Those files contain instructions to process data and combine the results. Early forms of simultaneous processing were conducted on one machine that contained many separately programmed computing devices, i.e. parallel processing. Subsequent iterations led to files, programs and tasks being shared amongst many separate computing devices in a peer to peer or peering fashion, called massively parallel processing. In this architecture, tasks and functions are being distributed and files are being shared over a disparate but discrete network and all of the processed data solutions are returned to a central processor for control. This type of networking does not employ distributed shared functionality for any complete task or function but does provide an example of peer to peer file sharing architecture for partial distribution of tasks and functions. More recently file sharing architectures have been deployed as free open source or shared software for peer to peer file sharing networks, e.g. BitTorrent, Kazaa, Gnutella and Morpheus. Users are permitted to download data files including software applications by this means and share those files with other users. An initial data file originates on one or more dedicated servers and is downloaded to many end user devices. These devices replicate and share the downloaded files with other devices. This process enables the generation and support of a virtual server architecture. A recent example of this form of file sharing was the use by the European browser Opera of a modified version of BitTorrent software to distribute Opera browser software. These sharing methodologies are improvements on the models earlier described but do not incorporate fully distributed shared functionality.

Development of Internet access and network architecture has led to dedicated server groups or networks. These network servers control data tasks and functions for the distribution storage and management of data and communications. A server is a computer or processor dedicated to managing and providing connections between many computer devices or nodes. Servers also manage network traffic or access to peripheral devices, data storage or other resources.

A server may provide connections, access, security, routing, management, control, data, tasks, processing distribution and similar functions. Servers and server networks may use internal or external data storage. Server architecture and server network architecture may include without limitation any combination of the following:

Server to server

Server to server network

Server network to server network

Network to network

Device to device

One device to many devices

Many devices to many devices

Server to nodes and devices

Devices and nodes to server

Server to network interface device

Network interface device to server

Server to external data storage

External data storage to server

Current Internet distribution of data services covers a very broad spectrum including:

Online advertising

Marketing, sales, promotion

Content distribution

Commercial transactions

Business to business

Business to consumer

Specialized or customized platforms and software

Search engines

Browsers

Networking

File sharing

Multi-access or multiple-user environments

Online gaming

Mobile communications

All of these are controlled by dedicated server centric architecture. The data, tasks, management functions and content are served i.e. controlled by and through dedicated servers or server networks. The majority of commercial and consumer Internet traffic for all of the examples described above is controlled by dedicated server centric distribution.

### A BRIEF SUMMARY OF THE INVENTION

In an exemplary embodiment of the invention described herein a commercial method and trading model for acquisition, redistribution, enhancement, combination and sale of Internet access and media content may include performance of any of the elements of the following Internet trading development plan in any sequence or combination, whether alone or in conjunction with any other means and whether or not said means are disclosed herein.

Combine Internet access and media content distribution for Internet broadcasting or podcasting.

Derive revenue from online advertising and content subscription or download payments.

Use existing infrastructure for deployment of a narrowband or broadband platform featuring portable, mobile, peer-to-peer, media access.

Provide users with Internet access.

Create interactive sites featuring multimedia metadata integration.

Deploy an intuitive browser or search engine

Deploy a distributed or shared peer-to-peer network platform

Identify and annotate objects of interest to individual users.

Provide a shared platform linking sites to specialized content and events.

Provide a platform for Internet access via dedicated sites.

Assist end users and advertisers in creating sites for media content distribution, branding, advertising and sponsorship.

Acquire Internet access and media content distribution.

Auction, trade or sell Internet access for online advertising, marketing, media distribution or branding use.

Provide management, marketing and access services.

In a further exemplary embodiment this invention concerns a method and means to provide distributed shared functionality as a data processing, information processing or networking platform and as a means to enable shared access over any form of communications, telecommunications or information infrastructure including shared Internet and Intranet access. By way of example a distributed platform in the form of a virtual net-centric server could be based on distributed shared functional architecture. This could use a method, which employs computing devices and nodes, to aggregate and distribute a plurality of tasks, data and functions for a plurality of purposes. The distributed shared functional architecture described in this invention could be used without dedicated servers or server networks or could be combined with network interfaces, network devices, network servers, network connections of any other sort whether real or virtual, dedicated servers or server networks.

This invention further concerns a method and means to share or distribute tasks and functions and to distribute shared tasks or functions across a platform consisting of or on a data processing or information processing device or contained in a computer device or a network of such devices as a function of distributing shared files or sharing files for data processing tasks.

In an exemplary embodiment the method of enabling the various functions, tasks, features and sequential relationships, which are contained in this invention, includes performing the operation of some or all of the following steps:

Identify the functions to be performed.

Identify the tasks necessary to implement those functions.

Identify the functions necessary to enable those tasks.

Select those functions or tasks.

Generate control data files to execute the specific functions or tasks.

Divide the control data files into an arbitrary sequence of discrete files.

Generate a unique sequential address for each discrete file.

Instruct each discrete file to include a unique sequential address.

Instruct each discrete file to execute at least a portion of a function or task.

Instruct each discrete file to make a copy of the discrete file.

Instruct the copied files to locate the sequential discrete files.

Instruct the copied files to attach the sequential discrete files that form part of the control data file for the complete function or task.

Instruct the copied files to make further copies of the sequential files.

Instruct the copied files to divide the control data files in sequential fashion.

Instruct each divided file to locate other divided files in sequential fashion.

Instruct each divided file to recombine the discrete files into a control data file.

Instruct the control data file to continuously perform the operations of dividing, copying, sequencing, locating and reassembling duplicate discrete portions of the file into sub-files.

Instruct the sub-files to continuously perform the operations of dividing, copying, sequencing, locating and reassembling duplicate discrete portions of the sub-file into control data files.

Instruct the sub-files to continuously execute at least a portion of a function or task.

Instruct the control data file to complete the assigned function or task.

### BRIEF DESCRIPTION OF THE DRAWINGS

Not Applicable.

### DETAILED DESCRIPTION OF THE INVENTION

An exemplary method for trading Internet access and media content by commercial means might be enabled by the embodiments and methods specifically described herein. Such method could use any or all of the elements identified in this description in any combination, individually or in a plurality of means. This list of elements is not intended to limit the enabling embodiments in any way. Reference to said elements is intended merely to serve as an indication of significant features and prior art that could be incorporated in the subject invention.

Combine Internet access and media content distribution for Internet broadcasting or podcasting.

Derive revenue from online advertising and content subscription or download payments.

Use existing communications, telecommunications or information infrastructure for deployment of a narrowband or broadband platform featuring portable, mobile, peer-to-peer, media access.

Provide users with Internet access.

Create interactive sites featuring multimedia metadata integration.

Deploy an intuitive browser or search engine

Deploy a distributed or shared peer-to-peer network platform

Identify and annotate objects of interest to individual users.

Provide a shared platform linking sites to specialized content and events.

Provide a platform for Internet access via dedicated sites.

Assist end users and advertisers in creating sites for media content distribution, branding, advertising and sponsorship.

Acquire Internet access and media content distribution.

Auction, trade or sell Internet access for online advertising, marketing, media distribution or branding use.

Provide management, marketing and access services.

Purchase and resale of bulk Internet access.

Identify number and demographic grouping of subscribers and division of time and calendar segments.

Overlay, insert, stream, or otherwise include additional content.

Control access and management functions using dedicated hardware and software.

Provide an interface to allow end users to use Internet access.

This invention may require management and organization of some or all of the following data and functions:

Grading and indexing Internet access providers.

Identifying coverage, location, service area, and customer demographics.

Maintaining quality of service.

Installed network infrastructure.

Bandwidth and throughput rates.

Managing and mapping events, locations, sites, demographics, profiling, Internet access and online advertising.

Comparative analysis of Internet access provider for quality of service, location, coverage area, demographic customer profile, infrastructure, system data, bandwidth and data throughput rates.

Marketing Internet access to online advertisers and others.

Monitoring functions.

Analyzing data, systems, sites, applications, equipment and related information.

For the purposes of this invention bulk Internet access could be sold alone or bundled with the following applications:

Site management, access services and software.

Data mining, profiling and indexing functions.

Data acquisition and marketing.

Mapping, indexing, grading, managing and auctioning, sites, locations and events.

Online advertising sales.

Enabled universal graphic user interface capabilities to access Internet destinations.

Enabled cross platform front end capabilities to access Internet platforms.

Improved Internet functionality through advanced coding for more efficient data management and network distribution.

For the purposes of a commercial trading model as described in this invention revenue may be generated from the following operations or services:

Creation of dedicated sponsorship, media content distribution, branding and advertising sites.

Auctions of Internet access for online advertising, marketing, media distribution or branding.

Management, marketing and access services.

Improved Internet functionality through advanced coding software

Data management and network distribution.

Internet access or media content distribution deals with specific providers.

Bulk Internet access sales and arbitrage.

Grading and Indexing Internet access provider.

Analysis of Internet access provider and demographic data.

Integration and monitoring services.

Bulk Internet access enhancement.

Analyzing data systems.

Site management.

Data mining, profiling and indexing.

Data and feature extraction, acquisition and marketing.

Online advertising sales.

Software licensing.

Raw and refined data sales.

Click through traffic use.

Online advertising and payments for content subscription or downloads.

This invention further concerns a method and means to provide distributed shared functionality as a data processing, information processing or networking platform and as a means to enable shared access over any form of communications, telecommunications or information infrastructure including shared Internet and Intranet access. Nodes or devices can be used for sharing tasks and functions in active or passive modes. Nodes or devices can provide bridging capabilities by singular or plural means. For the purposes of this invention the term and description of nodes or devices may include in singular or plural fashion at least the following devices. This description is not intended to be comprehensive nor is it intended to exclude any like or similar device to those described herein or any like or similar device which performs a similar function or purpose to any such device.

Any information or data processing device contained on an integrated circuit.

Any information or data processing device contained on a microprocessor.

Any information or data processing device contained on a chip.

Any information or data processing device contained on a microchip.

Any information or data processing device contained on a chip set.

Any information or data processing device contained on a computing device containing a plurality of other devices.

Any information or data processing device contained on a device containing one or more data processing devices.

Any information or data processing device contained on one or more computing devices.

Any information or data processing device contained on one or many computing devices contained in a single computing device.

Any information or data processing device contained on one or many computing devices contained in one or many computing devices.

Any information or data processing device contained on a single computing or data processing platform.

Any information or data processing device contained on a plurality of computing or data processing platforms.

This invention concerns a method and means to share or distribute tasks and functions across a platform consisting of or on a data processing or information processing device or contained in a computer device or a network of such devices as a function of distributing shared files or sharing files for data processing tasks.

This invention further concerns a method and means to distribute shared tasks or functions across a platform consisting of or on a data processing or information processing device or contained in a computer device or a network of such devices as a function of distributing shared files or sharing files for data and information processing tasks.

An exemplary method of deploying distributed shared functionality might be enabled by the embodiments specifically described herein. Such method may use any or all of the elements identified in this description in any combination, individually or in a plurality of means.

The foregoing means and method are described as exemplary embodiments of the inventions. These examples are intended to demonstrate that any of the aforementioned steps may be used alone or in conjunction with any other steps in the sequences described and in any other sequences.

Additional means for enhancement of Internet access could include multiple-user, multiple access environments and sites. Additional content for enhancement of Internet access could include data in any form including, but not limited to, visual images, graphic images, computer generated visual or graphic images, animation or simulation whether or not computer generated, interactive media access of any description including single player or multi player games, video, audio, software applications and software programs.

It will be apparent to any of those persons who are knowledgeable and skilled in the art that the aforementioned descriptions are merely examples of possible methods of enabling the inventions described. These descriptions are not intended in any way to limit or exclude alternative embodiments or uses of the inventions. All and any forms or embodiments or uses of the inventions are considered to be addressed and taught by the methods and descriptions illustrated and contained herein.

It is understood that the terms and descriptions used in connection with the devices, examples or implementations described herein are for illustrative purposes only and any variation, modifications or changes therein are intended to be included within the spirit and purview of this application and scope of the appended claims and combinations thereof.

It is also understood that the examples and implementations described herein are for illustrative purposes only and that various modifications or changes in light thereof will be suggested to persons skilled in the art and are to be included within the spirit and purview of this application and scope of the appended claims and combinations thereof.

What is claimed is:

1. A method for trading Internet access and media content by commercial means whereby the trading model includes the means to at least develop at least a business for at least the acquisition, redistribution, enhancement, combination and sale of Internet access and media content so as to include some or all of the following steps:
where at least Internet access and at least media content are distributed alone or in combination,
where at least Internet access and at least media content are broadcast or podcast alone or in combination on the Internet,
where at least Internet access and at least media content are distributed, broadcast or podcast,
where at least revenue is at least derived from at least online advertising, at least payments for content subscription or at least downloads,
where at least a form of at least the existing communications, telecommunications or information infrastructure is used for at least the deployment of a narrowband or broadband platform featuring at least portable, mobile, peer to peer, media access,
where at least users are at least provided with Internet access,
where at least interactive sites are at least created,
where at least interactive sites featuring at least multimedia or at least metadata integration are at least created,
where at least a shared platform linking sites to specialized content and events is at least provided,
where at least an intuitive browser or search engine is at least deployed,
where at least a distributed or shared peer-to-peer network platform is at least deployed,
where at least objects of interest to individual users are at least identified and at least annotated,
where at least a platform for Internet access via dedicated sites is at least provided,
where at least end users and at least advertisers are at least assisted in creating sites for at least media content distribution, at least branding, at least advertising and at least sponsorship,
where at least Internet access and at least media content distribution are at least acquired,
where at least Internet access for online advertising, marketing, media distribution or branding use is at least auctioned, at least traded or at least sold,
where at least management, at least marketing and at least access services are at least provided,
where at least bulk Internet access is at least purchased and at least resold,
where at least number and demographic grouping of at least subscribers are at least identified,
where at least discrete time and at least discrete calendar segments are at least divided,
where at least additional content is at least overlaid, inserted, streamed, or at least otherwise included,
where at least access and at least management functions using at least dedicated hardware and software are at least controlled,
where at least an interface is at least provided to allow end users to at least use Internet access.

2. The method of claim 1, for trading Internet access and media content whereby the means to develop at least a business for at least the acquisition, redistribution, enhancement, combination and sale of Internet access and media content may require management and organization of some or all of the following data and functions and may include some or all of the following steps:
whereby at least Internet access providers will be graded and indexed,
whereby at least coverage, at least location, at least service area and at least customer demographics will be at least identified,
whereby at least quality of service will be at least maintained,
whereby at least installed network infrastructure will be at least used,
whereby at least bandwidth and throughput rates will be at least identified,
whereby at least events, at least locations, at least sites and at least demographics will be at least managed and at least mapped
whereby at least profiling, at least Internet access and at least online advertising will be at least managed and at least mapped,
whereby at least a comparative analysis of at least an Internet access provider for at least quality of service will be made,
whereby at least a comparative analysis of at least an Internet access provider for at least location, at least a coverage area, at least a demographic customer profile will be made,
whereby at least a comparative analysis of at least an Internet access provider for at least an infrastructure, at least system data, at least a bandwidth and at least data throughput rates will be made,
whereby at least Internet access will at least be marketed to at least online advertisers,
whereby at least functions will be at least monitored,
whereby at least data, at least systems, at least sites, at least applications, at least equipment and at least related information will be at least analyzed.

3. The method of claim 1, for trading Internet access and media content whereby the means to develop at least a business for at least the acquisition, redistribution, enhancement, combination and sale of Internet access and media content could at least include a method where bulk Internet access could at least be sold alone or bundled with applications and services by use of some or all of the following steps:
whereby at least sites, at least access services and at least software are at least managed,
whereby at least data mining, at least profiling and at least indexing functions are at least managed,
whereby at least data is at least acquired and at least marketed,
whereby at least mapping, at least indexing, at least grading, at least managing and at least auctioning, at least sites, at least locations and at least events are at least performed,
whereby at least online advertising and at least sales are at least managed,
whereby at least universal graphic user interface capabilities to at least access Internet destinations are at least enabled,
whereby at least cross platform and at least front end capabilities to at least access Internet platforms are at least enabled,
whereby at least Internet functionality through advanced coding for more efficient data management and network distribution is at least improved,

4. The method of claim 1, for trading Internet access and media content whereby the means to develop at least a business for at least the acquisition, redistribution, enhancement, combination and sale of Internet access and media content includes at least the generation of at least revenue from some or all of the following operations or services:
whereby at least dedicated sponsorship, at least media content distribution, at least branding and at least advertising sites are at least created,
whereby at least Internet access for at least online advertising, at least marketing, at least media distribution and at least branding are at least auctioned, at least traded and at least sold,
whereby at least management, at least marketing and at least access services are at least sold,
whereby at least Internet functionality through at least advanced coding software is at least improved,
whereby at least data management and at least network distribution are at least sold,
whereby at least Internet access or at least media content distribution are at least sold to at least specific providers,
whereby at least bulk Internet access is at least sold or at least made subject to sales arbitrage,
whereby at least Internet access providers are at least graded and indexed,
whereby at least Internet access providers and at least demographic data are at least analyzed,
whereby at least integration and at least monitoring services are at least sold,
whereby at least bulk Internet access enhancement is at least sold,
whereby at least analyzing data systems are at least sold,
whereby at least site management is at least sold,
whereby at least data mining, at least profiling and at least indexing are at least sold,
whereby at least data and at least feature extraction, at least acquisition and at least marketing are at least sold,
whereby at least online advertising is at least sold,
whereby at least software is at least licensed for at least sale,
whereby at least raw and at least refined data are at least sold,
whereby at least click through traffic is at least sold,
whereby at least online advertising and at least content subscription or at least downloads are at least sold.

5. A method and means to at least share or at least distribute at least tasks and at least functions and to at least distribute at least shared tasks or at least shared functions across at least a platform; such platform consisting of or on at least a data processing or at least an information processing device or node; such platform at least contained in at least a computer device or node or at least a network of at least such devices or nodes; such method or such platform to provide at least a means or at least a function of at least distributing shared files or at least sharing files for at least data processing or at least information processing tasks.

6. The method of claim 5, to provide distributed shared functionality as at least a data processing, at least an information processing or at least a networking platform and further to provide at least a means to at least enable shared access over any form of at least communications, at least telecommunications or at least information infrastructure including at least Internet and at least Intranet access.

7. The method of claim 5, to provide for distributed shared functionality by the use of at least a data processing or at least an information processing device or by means of at least a computer device or at least a network of at least such devices; the method comprising the use of at least devices for sharing at least tasks and at least functions in at least active or at least passive modes; the singular device or plurality of devices used for such method to include at least those devices or at least any combination of those devices intended to be used to provide distributed shared functionality to include at least the following means:
whereby any information or data processing device is contained on at least an integrated circuit,
whereby any information or data processing device is contained on at least a micro processor,
whereby any information or data processing device is contained on at least a chip,
whereby any information or data processing device is contained on at least a micro chip,
whereby any information or data processing device is contained on at least a chip set,
whereby any information or data processing device is contained on at least a computing device containing at least a plurality of other devices
whereby any information or data processing device is contained on at least a device containing at least one or more data processing devices,
whereby any information or data processing device is contained on at least one or more computing devices,
whereby any information or data processing device is contained on at least one or at least many computing devices contained in at least a single computing device,
whereby any information or data processing device is contained on at least one or at least many computing devices contained in at least one or many computing devices,
whereby any information or data processing device is contained on at least a single computing platform or on at least a single data processing platform,
whereby any information or data processing device is contained on at least a plurality of computing platforms or on at least a plurality of data processing platforms,
whereby any information or data processing device can be used for at least sharing and at least distributing at least tasks and least functions,
whereby any information or data processing device can be used in at least an active or at least a passive mode,
whereby any information or data processing device can be used at least alone or at least in combination with at least any other such devices,
whereby any information or data processing device can be used to at least provide at least a communication conduit to at least one or at least a plurality of devices,
whereby any information or data processing device can be used in at least a similar fashion to perform at least a similar function or at least a similar purpose to at least one or at least a plurality of devices.

8. The method of claim 5, whereby a means to provide at least a distributed platform in the form of at least a virtual net-centric server could be based on at least distributed shared functional architecture by use of a method, which employs at least computing devices and at least computing nodes to perform at least some or all of the following steps:
whereby at least computing devices and at least computing nodes are used to at least aggregate and at least distribute at least a plurality of tasks, at least a plurality of data and at least a plurality of functions for at least a plurality of purposes,
whereby at least distributed shared functional architecture can at least include or at least be combined with at least network interfaces, at least network devices, at least network nodes, at least network servers, at least network connections of any other sort whether real or virtual, at least dedicated servers or at least server networks.

9. The method of claim 5, whereby a means to at least share or at least distribute at least tasks and at least functions at least includes a means to at least share and at least distribute at least the shared and at least the distributed tasks and functions by the use of any data processing or information processing devices or nodes.

10. A method and means to at least deploy at least distributed shared functionality by at least enabling at least the various functions, at least the various tasks, at least the various features and at least the various sequential relationships, which includes performing at least some or all of the following steps:
whereby at least the functions to be performed are at least identified,
whereby at least the tasks necessary to at least implement at least the necessary functions are at least identified,
whereby at least the functions necessary to at least enable the necessary tasks are at least identified,
whereby at least the necessary functions or at least the necessary tasks are at least selected,
whereby at least control data files are at least generated to execute at least the specific tasks and at least the specific functions,
whereby at least the control data files are at least divided into at least an arbitrary sequence of at least discrete files,
whereby at least a unique sequential address for at least each discrete file is at least generated,
whereby at least each discrete file is at least instructed to include at least a unique sequential address,
whereby at least each discrete file is at least instructed to execute at least a portion of a function or at least a portion of a task,
whereby at least each discrete file is at least instructed to at least make a copy of at least the discrete file,
whereby at least the copied files are at least instructed to at least locate at least the sequential discrete files,
whereby at least the copied files are at least instructed to at least attach at least the sequential discrete files that form at least part of at least the control data file for at least the complete function or at least the complete task,
whereby at least the copied files are at least instructed to at least make further copies of at least the sequential files,
whereby at least the copied files are at least instructed to at least divide at least the control data files in at least sequential fashion,
whereby at least each divided file is at least instructed to at least locate at least other divided files in at least sequential fashion,
whereby at least each divided file is at least instructed to at least recombine at least the discrete files into at least a control data file,
whereby at least the control data file is at least instructed to at least continuously perform at least the operations of at least dividing, at least copying, at least sequencing, at least locating and at least reassembling at least duplicate discrete portions of the file into at least sub-files,
whereby at least the sub-files are at least instructed to at least continuously perform at least the operations of at least dividing, at least copying, at least sequencing, at least locating and at least reassembling at least duplicate discrete portions of at least the sub-file into at least control data files,
whereby at least the sub-files are at least instructed to at least continuously execute at least a portion of at least a function or at least a portion of a task,
whereby at least the control data file is at least instructed to at least complete at least the assigned function or at least the assigned task.
